(19) United States
(12) Patent Application Publication
(10) Pub. No.: US 2010/0023650 A1
(43) Pub. Date: Jan. 28, 2010

(54) SYSTEM AND METHOD FOR USING A SMART CARD IN CONJUNCTION WITH A FLASH MEMORY CONTROLLER TO DETECT LOGON AUTHENTICATION

(75) Inventors: Sylvain Prevost, Austin, TX (US); Ksheerabdhi Krishna, Cedar Park, TX (US); Ruchirkumar D. Shah, San Jose, CA (US); Mehdi Asnaashari, Danville, CA (US)

Correspondence Address: THE JANSSON FIRM, 3616 Far West Blvd, Ste 117-314, AUSTIN, TX, 78731, US

(73) Assignee: GEMALTO INC, Austin, TX (US)

(21) Appl. No.: 11/938,772

(22) Filed: Nov. 12, 2007

(51) Int. Cl. G06F 3/00; G06F 12/00

(52) U.S. Cl. 710/16; 711/115; 711/E12.001

(57) ABSTRACT

A system and method of operating a device connected to a host computer in a manner to preserve knowledge of logon authentication status to the host computer. Upon initialization of the device perform a pattern matching operation of an instruction sequence received by the second microcontroller. When the instruction sequence matches a prestored sequence indicative of performance of a logon process on the host computer tracking a logon state by the second microcontroller. Exchanging the logon state between the second and first microcontrollers such that when the second microcontroller resets, the second microcontroller may recover the logon state from the first microcontroller. Other systems and methods are disclosed.

### CROSS-REFERENCE TO RELATED APPLICATIONS

This application is related to the following patent applications co-filed herewith:

<<List of the other six applications to be added by amendment.>>

### BACKGROUND OF THE INVENTION

The present invention relates generally to secure USB flash memory devices and more particularly to USB flash memory devices having both a microcontroller and a smart card.

With the small physical size of computer memories having large address spaces, it has become possible to store relatively large quantities of data on small portable memory devices. This portability has made it possible for users to literally carry their important data in their pocket either for the purpose of sharing the data with other individuals or to have information available without carrying bulkier and less portable forms of data storage.

USB flash drives are one example of such small portable devices that are becoming a very popular mechanism for storing computerized information and for physically moving the stored information from one computer to another. There are many popular uses; some common uses include personal data transport and data transfer.

With the portability of data storage devices come security risks. There have been several highly publicized cases of private data being lost from misplaced or stolen laptop computers. Similar risks arise with the use of USB flash drives: being small, they are easily misplaced, often they are carried in a user's pocket and can then, like other small items carried in that fashion, inadvertently fall out of the pocket undetected. In the event of loss of the device, if the owner of the device has stored sensitive private information on it, that person would be more comfortable knowing that the private data could not be accessed without authorization, e.g., without being authenticated as the owner of the device.

There is also a growing culture of using USB flash drives to move data to computers belonging to persons other than the owner of the USB flash drive. In that scenario the owner of the USB flash drive provides the USB flash drive to another person for connection to that persons computer via a USB port either for the purpose of receiving data files from the owner of the computer or vice versa. However, because the owner of the USB flash drive does not typically have control of the computer, the USB flash drive owner is subjected to having data moved, intentionally or unintentionally, from the USB flash drive to the computer to which it is being attached, or viewed by the owner of the computer. Furthermore, the owner of the computer could, again either with intent or inadvertently, cause information stored on the USB flash drive to be deleted or corrupted.

Thus it is desirable to avoid the threat of being subjected to some form of attack from the computer to which the drive is attached.

Encryption technology is available on many computers. Thus, one way to avoid some of the aforementioned problems is to use the encryption processing capabilities to encrypt and decrypt files stored on the USB flash memory device. While that solution may work to solve specific needs of particular users, it is not a good general solution to the data security problems that arise with USB flash memory devices. One problem is that multiple encryption standards exist. Thus, the encryption technology used to encrypt a file on one computer may not be available when the same file is to be decrypted on another computer. A more severe issue is that often a user would store the encryption key on the computer with which the USB flash memory device is most often used. Thus, the likelihood that the computer and USB flash memory device are lost together or stolen together is high and consequently a hacker may be able to find the encryption key for the USB flash memory device somewhere on the computer.

To address the above-mentioned concerns, several manufacturers, including, Lexar Media, Inc. of Fremont, Calif. and Kingston Technology Company, Inc. of Fountain Valley, Calif., have introduced USB flash memory devices that provide encryption of a data zone having private data. The encryption and decryption is performed by the USB flash memory microcontroller and the encryption key is stored inside the microcontroller. While this solution provides a higher level of security than USB flash memory devices that have no security features and also improves security with respect to using a host computer for encryption and decryption, it is a solution that is vulnerable to certain attacks. For example, denial of service attacks may be launched against files in the private data zone by deleting files from that area of the device. As discovered by the smart card industry, hackers have developed many clever techniques for deducing the activity inside a microcontroller, for example, examining power consumption patterns, and can use those techniques for determining encryption keys.

From the foregoing it will be apparent that there is still a need for a USB flash memory device that provides yet a higher level of data security to protect data stored on thereon.

### BRIEF DESCRIPTION OF THE DRAWINGS

FIG. 1 is a block diagram illustrating a use scenario of a USB flash memory device.

FIG. 2 is a block diagram illustrating a high-level view of the architecture of a prior art USB flash memory device having a USB flash memory microcontroller and a NAND memory storage area.

FIG. 3 is a block diagram illustrating a high-level view of the architecture of a USB flash drive incorporating a smart card circuit operating in cooperation with a USB microcontroller.

FIG. 4 is a block diagram illustrating an exemplary layout of the addressable space of the memory of the flash memory of the USB flash drive of FIG. 3.

FIG. 5 is a block diagram illustrating a high-level view of the architecture of a smart card module of FIG. 3.

FIG. 6a is a schematic illustrating a user login on to a computer system.

FIG. 6b is a schematic illustrating a user using a smart card to logon onto a computer system.

FIGS. 7a-b are timing sequence diagrams illustrating the mechanism by which the USB flash drive microcontroller in conjunction with a smart card module of a USB flash drive having a smart card determines that an operating system logon operation has occurred.

FIG. 8 is a timing sequence diagram illustrating the operation to provide the smart card module with the knowledge that the logon operation has already been performed.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a USB flash drive having a smart card module operating in conjunction with the USB flash drive microcontroller provides an hitherto unavailable level of security. Furthermore, the USB flash drive with a smart card provides a mechanism by which single-sign on operations are efficiently, flexibly, and securely provided for.

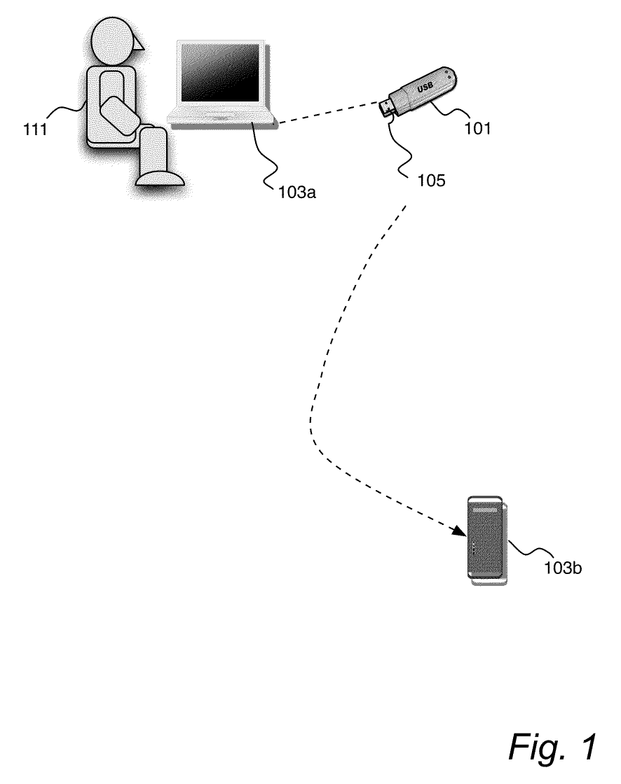

FIG. 1 is a schematic diagram illustrating a typical use of a USB flash drive 101. A user 111 operates a computer 103. On that computer the user 111 has stored certain files (not shown). It is often the case that a computer user 111 needs to access these same files at other locations. For example, a user 111 may need to access a file, which was created on a work computer, using his home computer 103. One way to transfer the file would be via a computer network or by sending the file via electronic mail. However, that may not always be practical.

An alternative is to physically move a copy of the file on a storage medium. USB flash drives 101 is one such storage medium. In the example of FIG. 1, a USB flash drive 101a having a USB connector 105 is inserted into a USB port of the user's computer 103a. The USB flash drive 101a then enumerates on the user's computer 103a¹. ¹ Herein, letter suffixes are used in conjunction with reference numerals to designate specific instantiations of a class of objects having common generic features. The class is referred to using numerals only. Thus, 103a is a specific computer 103. Any reference to a device solely by a numerical reference is meant to apply equally to all members of the class unless the context prohibits such an interpretation.

USB enumeration process includes performing a reset operation of a USB flash drive 101 and the USB flash drive 101 is assigned a unique identifier. In the case of a USB mass storage device, like a USB flash drive 101, a drive letter is assigned to the USB flash drive 101 so that a user 111 can access the USB flash drive 101 from his computer. Thus, at the conclusion of the enumeration process the USB flash drive 101 has been assigned a drive letter, e.g., “H:” or “K:”, by which the USB flash drive 101 is uniquely identified in the computer's operating system.

After the user 111 has inserted the USB flash drive 101a into the computer 103a and the USB flash drive 101a has enumerated, the user 111 can copy files from the computer 103a to the USB flash drive 101a. At this point, the files have become physically portable and the user 111 can move the files to another computer 103b by inserting the USB flash drive 101a into a USB port of that computer 103b. The user 111 can now read the file using the file browser or application programs on that computer 103b.

Of course, as with other storage drives on a computer, a USB flash drive 101 may be used to create, read, delete and otherwise manipulate files as permitted by the operating system and application programs running on the computers to which it is connected 103.

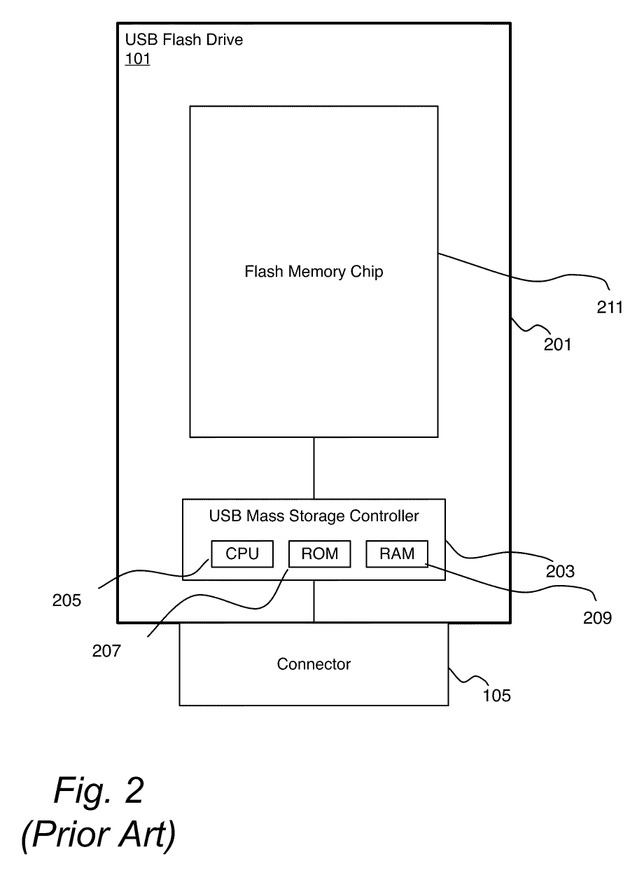

FIG. 2 is a high-level block diagram illustrating the basic components of a prior art USB flash drive 101. A USB flash drive 101 typically has a hard shell housing 201, e.g., plastic or aluminum, to contain and protect the internal components of the USB flash drive 101. At one end, the USB flash drive 101 has a connector for connecting the USB flash drive 101 to a host computer 103 and to provide a communications interface to the host computer 103 to which it is connected.

A prior art USB flash drive 101 further contains a USB mass storage controller 203. Flash memories are block-oriented and are subject to wear (a limit on the number of read-write cycles that a flash memory can handle). The USB mass storage controller 203 implements a USB host controller and provides a linear interface to block-oriented serial flash devices while hiding the complexities of block-orientation, block erasure, and wear leveling, or wear balancing. The controller contains a small RISC microprocessor 205 and a small amount of on-chip ROM 207 and RAM 209.

A USB flash drive 101 further contains a flash memory chip 211, typically a NAND flash memory chip, for storing data, e.g., computer files.

A USB flash drive 101 further contains a crystal oscillator for producing a clock signal, and may contain LEDs, write protect switches, and a myriad of non-electrical components for aesthetic or portability purposes. These are not important to the present discussion.

As discussed hereinabove, the mainstream prior art USB flash drive 101 is extremely vulnerable to security threats. These devices provide no defense against the risk that the data stored thereon would come into the wrong hands if the device is stolen or lost. Furthermore, when inserted into a stranger's computer 103, the data on a USB flash drive 101 may be either inadvertently or intentionally copied to that computer 103 or be deleted from the USB flash drive 101.

As further discussed hereinabove, there are prior art approaches to provide a certain level of security through the use of encryption services provided directly on the microcontroller 205. An alternative, that provides yet higher security, using a smart card module for providing certain security features is presented here.

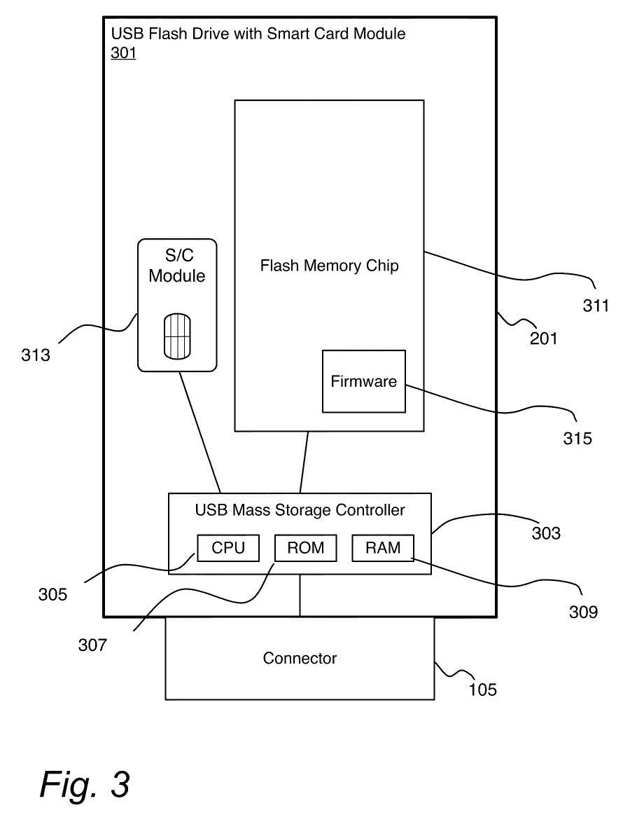

FIG. 3 is a block diagram illustrating a high-level view of the architecture of a USB flash drive 101 incorporating a smart card module for providing security functionality, e.g., authentication and cryptographic services, to enhance the security of data stored on the USB flash drive 101 (referred to hereinafter as a USB flash drive SC).

As with the prior art USB flash drive 101, a USB flash drive SC 301 is constructed with a USB connector 105 at one end, and has a USB flash drive microcontroller 303 having a microprocessor 305, a ROM 307, and a RAM 309, as well as a flash memory chip 311. Additionally the USB flash drive SC 301 contains a smart card module 313 connected to the USB flash drive microcontroller 303.

In one embodiment, the smart card module 313 is used by the USB flash drive SC 301 to authenticate a user and to provide certain cryptographic capabilities. Thus, for example, when the USB flash drive SC 301 is inserted into a computer 103, a logon screen may be presented to the user 111 requesting the user 111 to authenticate himself using a PIN or password. Authentication is then entirely a negotiation between the host computer 103 and the smart card module 313 with only the result presented to the USB flash drive microcontroller 303.

In one embodiment, the communication between the host the computer 103 and the USB flash drive SC 301 is performed using the USB mass storage protocol and the USB CCID (Chip Card Interface Device) protocol.

Operations of the USB flash drive microcontroller 303 are according to instructions stored in a firmware control program 315 stored in the flash memory 311. The firmware control program 315 contains start-up instructions executed on initialization of the USB flash drive SC 301. Several of the start-up procedures are discussed in greater detail hereinbelow.

As discussed hereinabove, USB enumeration is one function performed during startup. The USB flash drive SC 301 enumerates itself as a plurality of a USB mass storage drives and as a smart card interface device (akin to a USB smart card reader) to allow for communication using the CCID protocol. The firmware control program 315 contains the necessary instructions to act as a CCID device when the host computer 103 directs communication to the smart card module 313.

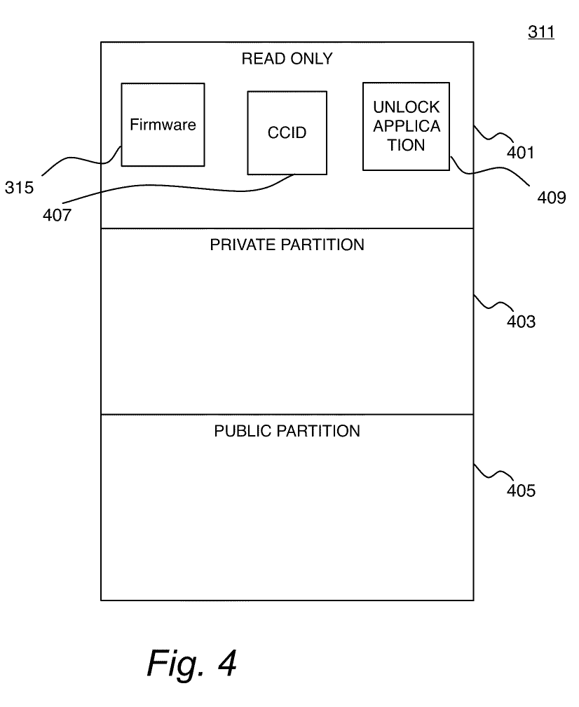

FIG. 4 is a block diagram illustrating an exemplary layout of the addressable space of the memory of the flash memory 311. In one embodiment, the addressable space of the flash memory is partitioned into three partitions: a read only partition 401, a private data partition 403, and a public data partition 405.

The read only partition 401 contains the control program firmware 315 and a CCID module 407 for managing interaction with the host computer 103 over the CCID protocol. In alternative implementations, the communication with the smart card module 313 is carried over the USB Human Interface Device (HID) protocol, or any other suitable communications protocol. For such alternatives, the CCID module 407 would be replaced with communications modules appropriate for such protocols allowing the USB flash drive SC 301 to enumerate as such a device, e.g., as an HID device.

The read only partition 401 also contains a host computer application program, the unlock application 409. The unlock application 409 may be an autorun application that automatically launches on the host computer 103 or may appear as a launchable application when the read only partition 401 is browsed to using the host computer 103 operating system.

The unlock application 409 may be used by a user 111 to perform several tasks associated with managing the USB flash drive SC 301. The unlock application 409 may, for example, be used by the user 111 to authenticate to the USB flash drive SC 301.

The USB flash drive SC 301 enumerates as three USB mass storage partitions, one corresponding to the read only partition 401, one as the private partition 403 and one as the public partition 405.

Upon initialization of the USB flash drive SC 301, the private partition 403 enumerates as a drive without media, i.e., a user 111 would be able to see a drive letter designated for the drive, however, it would appear as an empty disk drive.

Through the unlock application 409 the user 111 may unlock the private partition 403 to have access to files stored therein. In one embodiment, data in the private partition 403 is encrypted using an AES key (e.g., a 256 bit key). The AES key is stored in the smart card module 313. When the user 111 has authenticated using the unlock application 409 the smart card module 313 encrypts the AES key in a manner in which the USB flash drive microcontroller 303 can decrypt. The USB flash drive microcontroller 303 then uses the decrypted AES key to decrypt information stored in the private drive. The USB flash drive microcontroller 303 stores the AES key only temporarily. Thus, when the USB flash drive SC 301 is removed from the host computer 103 the AES key is only stored in the smart card module 313.

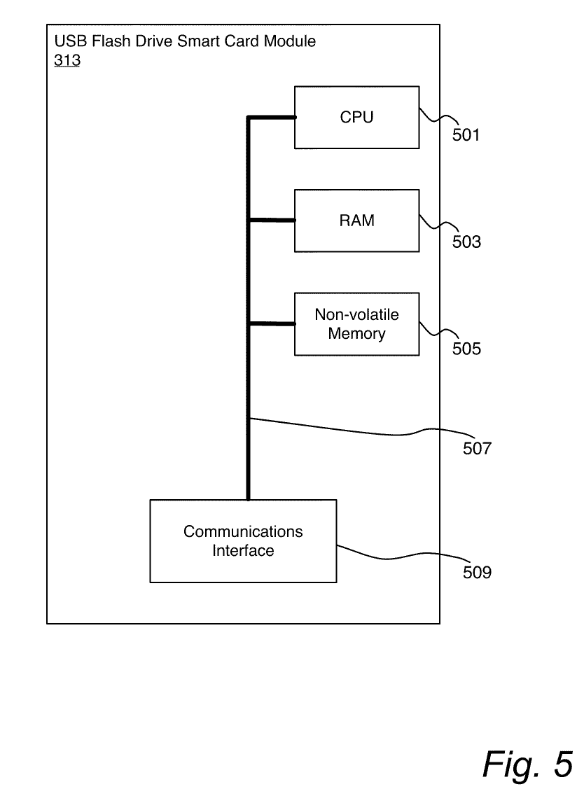

FIG. 5 is a block diagram illustrating a high-level view of the architecture of a smart card module 313 used in the USB flash drive SC 301. The smart card module 313 contains a central processing unit 501, a RAM 503, and a non-volatile memory 505. These components are connected via a bus 507. Also connected to the bus 507 is a communications interface 509 for providing a connection between the bus 507, and consequently, the CPU 501, RAM 503, and non-volatile memory 505, and the USB flash drive microcontroller 303.

In one embodiment communication between the USB flash drive microcontroller 303 and the smart card module 313 is over the ISO-7816 APDU protocol. Several special instructions are added to facilitate particular interactions required for coordinating the operations of the smart card module 313 and the USB flash drive microcontroller 303.

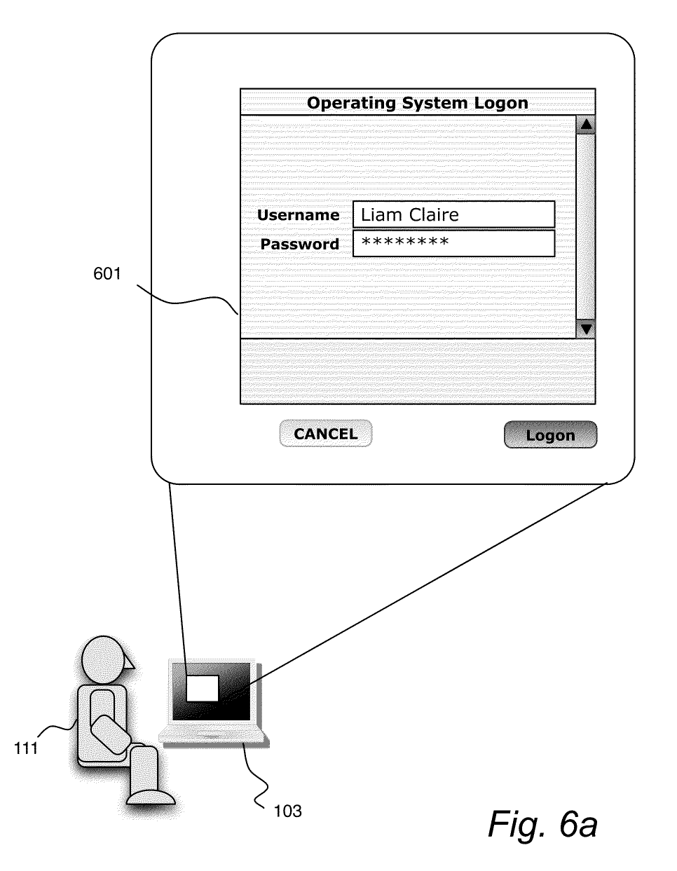

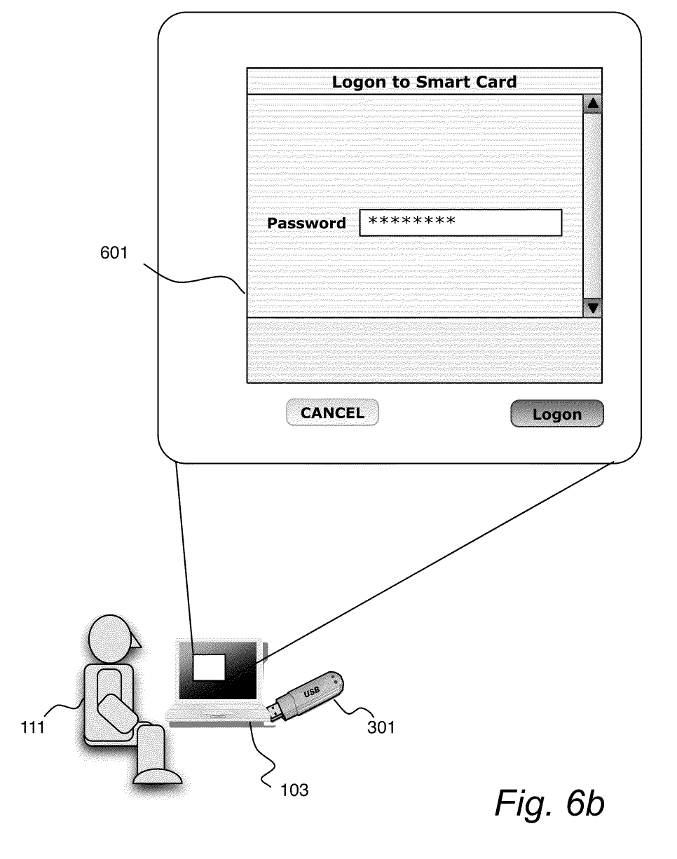

A useful application of smart cards is their ability to perform operating system logon. The traditional method of logging on to a computer system is illustrated in FIG. 6a which is a schematic illustrating a user login on to a computer system. A user 111, upon starting or restarting a computer 103, is prompted by the operating system to enter a username and password. A higher level of security, so called two-factor authentication, is achieved by having a smart card participate in the logon procedure. FIG. 6b, which is a schematic illustrating a user 111 using a smart card to logon onto a computer system 103, illustrates the latter scenario.

In the context of USB flash drive SC 301 this presents a new challenge. It would be desirable to use the USB flash drive SC 301 to perform single sign on wherein if a user 111 authenticates herself to the USB flash drive SC 301, she may be considered authenticated for a variety of services that the USB flash drive SC 301 provides authentication to. However, because the smart card module 313 is enumerated as a CCID device, or more accurately, because the USB flash drive microcontroller 303 enumerates as a series of USB mass storage devices and as a CCID device that is connected to the smart card module 313, the interaction between the host computer 103 and the smart card module 313 is directed by the CCID driver of the host computer 103 operating system. Many operating systems demand, with relative frequency, that CCID devices reset themselves; much more frequently than USB mass storage devices. Accordingly, a situation occurs in which the USB flash drive microcontroller 303 remains running while the smart card module 313 has been forced into a reset.

After such a forced reset, the smart card module 313 would be unable to know whether a logon to the operating system has taken place. The method described hereinbelow overcomes this issue by storing a login state in the USB flash drive microcontroller 303 and providing that logon state to the smart card module 313 after a reset operation of the smart card module 313.

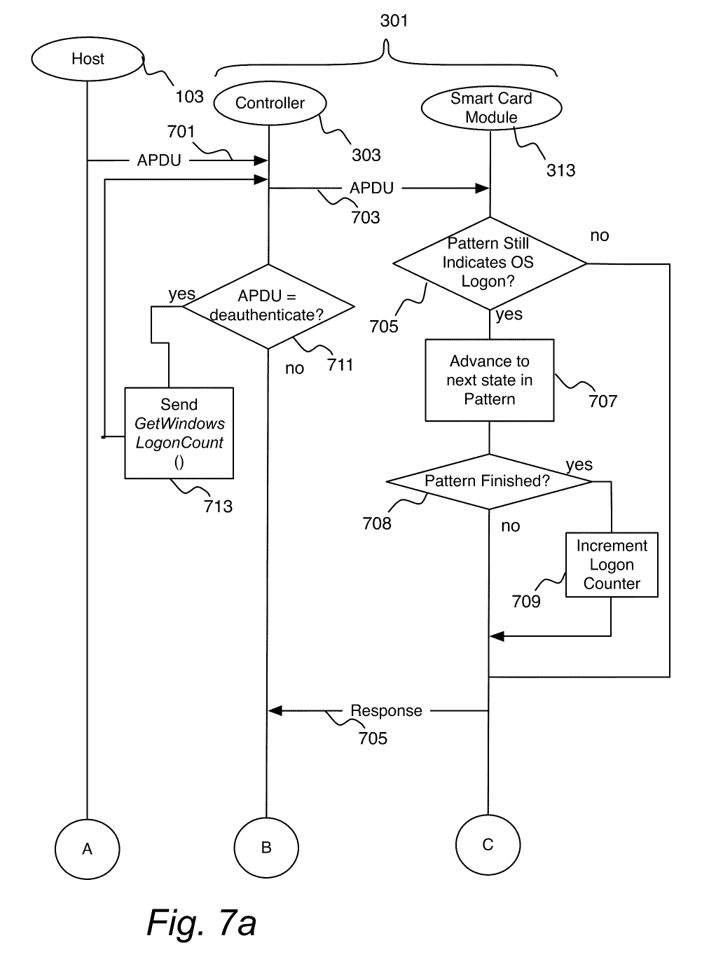

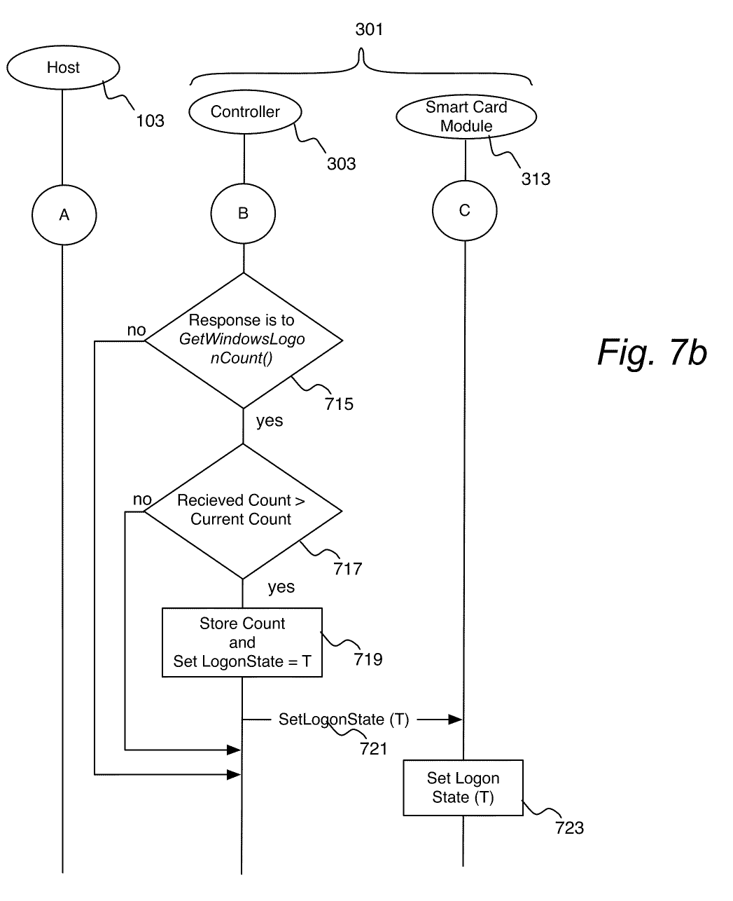

FIGS. 7a-b are timing sequence diagrams illustrating the mechanism by which the USB flash drive microcontroller 303 determines that an operating system logon operation has occurred. When the smart card module 313 has concluded that an operating system logon has occurred, a logon counter, logon counter, is advanced 709. The USB flash drive microcontroller 303 compares a logon counter, logon counter′, that it maintains, to the smart card module 313 maintained logon counter. If the smart card module 313 maintained logon counter is greater than the logon counter′ maintained by the USB flash drive microcontroller 303, the USB flash drive microcontroller 303 concludes that a logon has occurred and stores that information in a state variable, LogonState.

Generally speaking communication between the host computer 103 and the smart card module 313 is by way of USB CCID transactions to the USB flash drive microcontroller 303, message 701. The USB flash drive microcontroller 303 strips the USB headers, determines that the message is a CCID message and forwards the message as an APDU to the smart card module 313, message 703. The smart card module 313 responds to the USB flash drive microcontroller 303, message 705.

A smart card assisted operating system logon (for example, to a Microsoft Windows operating system) consists of a predictable pattern of APDU operations. The smart card module 313 maintains a state machine to track whether the command stream is indicative that an operating system logon is occurring. A first state in that state machine may be that the very first command after a power up is an authentication, i.e., an attempt to authenticate a user to the smart card module 313. Next, a sequence of cryptography operations occur. Finally, a deauthentication operation concludes the logon sequence.

For each received command, the smart card module 313 determines if the received command matches a command that advances the current state in the pattern-matching state machine, step 705. If so, the current state is advanced in the pattern-matching state machine, step 707, until the pattern has finished, step 708. When the pattern has finished, the smart card module 313 advances the logon counter 709.

Because the USB flash drive microcontroller 303 passes APDU commands for the smart card module 313, USB flash drive microcontroller 303 can perform some analysis of those commands, for example, looking for commands of particular concern to the USB flash drive microcontroller 303. One such command is the deauthenticate command. If an APDU instruction indicates that the host computer 103 is directing the smart card module 313 to deauthenticate, step 711, the USB flash drive microcontroller 303 uses that instruction to trigger asking the smart card module 313 what the current logon count value is by issuing a GetWindowsLogonCount, step 713, which is transmitted to the smart card module 313 as a message 703. In this case, because the last command was deauthenticate, the smart card module 313 would not be in a login pattern matching state and would merely respond to the USB flash drive microcontroller 303, step 705.

If a response from the smart card module 313 is to a GetWindowsLogonCount( ), step 715, and the received count (logon count) is greater than the logon count maintained by the USB flash drive microcontroller 303 (logon count′), step 717, then the USB flash drive microcontroller 303 concludes that a logon operation has been performed and, therefore, stores the new count in its logon count′ variable and sets the LogonState′ to True, step 719. The USB flash drive microcontroller 303 then transmits a direction to the smart card module 313 to also set its logon state to true, message 721, and consequently the smart card module 313, in response, sets its LogonState to true, step 723.

As discussed above, the host computer 103 is prone to reset the smart card module 313 periodically. Such resets manifest themselves as a powerdown( ) command followed by a powerup( ) command. The USB flash drive microcontroller 303 detects the powerdown-powerup sequence and responds by transmitting to the smart card module 313 a direction to set the logon state to True, step 721.

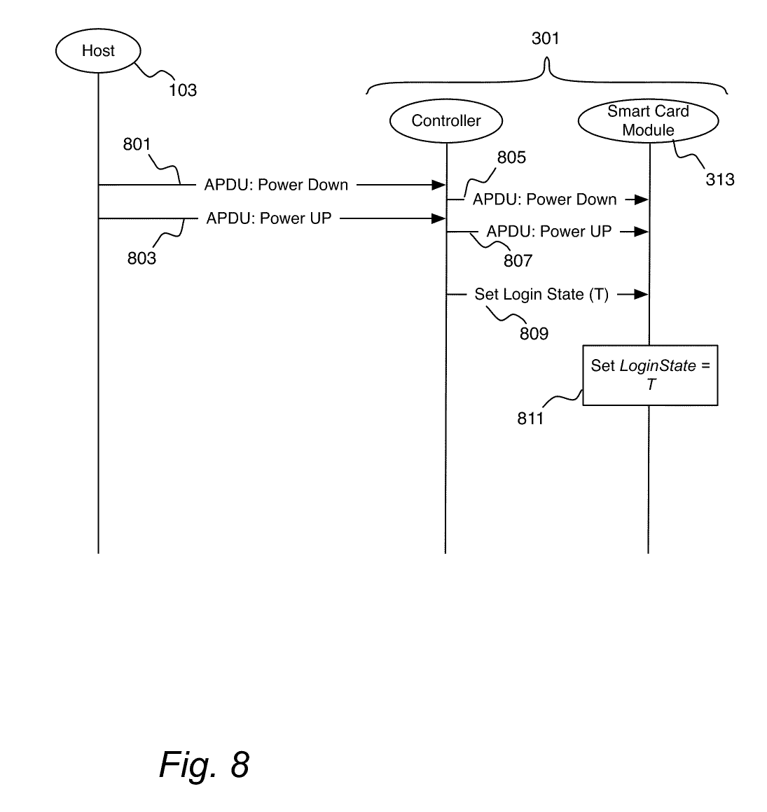

FIG. 8 is a timing sequence diagram illustrating the operation to provide the smart card module 313 with the knowledge that the logon operation has already been performed and, therefore, to set the logon state to True.

A reset is transmitted from the host computer 103 as a powerdown message 801 followed by a powerup message 803. These messages, like all normal APDU messages, are passed on to the smart card module 313, messages 805 and 807. Because the sequence of power down followed by power up is indicative that the smart card module 313 has been reset, the USB flash drive microcontroller 303 then transmits a SetLoginState(T), step 809, command to direct the smart card module 313 to set its logon state to True, which the smart card module 313 does, step 811.

The logon detection pattern should be expected to be operating system dependent and can change from operating system release-to-release. However, the patterns are easily determined from examining the instruction sequences transmitted to the smart card module 313 after a power up. Appendix A provides a code listing for detecting a logon operation for the Microsoft Windows XP operating system and may be considered an example implementation of the state machine method of detecting a logon operation presented hereinabove.

From the foregoing it will be apparent that a USB flash drive SC 301 provides an efficient, flexible, and secure mechanism for maintaining a logon state persistent over a USB session of the USB flash drive microcontroller 303 even when the smart card module 313, i.e., the device that is responsible for performing logon authentication has been reset. This provides a user with a great utility in that logon operations do not have to be repeated when the smart card module 313 has been reset thereby providing the possibility of a single logon.

Although specific embodiments of the invention have been described and illustrated, the invention is not to be limited to the specific forms or arrangements of parts so described and illustrated. The invention is limited only by the claims.

We Claim:

1. A method of operating a device connected to a host computer in a manner to preserve knowledge of logon authentication status to the host computer, comprising:
upon initialization of the device, operating a second microcontroller of the device to perform a pattern matching operation of an instruction sequence received by the second microcontroller;
in response to the sequence of operations matching a prestored sequence indicative of performance of a logon process on the host computer involving cooperation of the device, tracking a second logon state by the second microcontroller;
operating a first microcontroller to receive instructions from the host computer and intended for the second microcontroller;
operating the first microcontroller to maintain a first logon state indicative of the logon state of the device;
operating the first microcontroller to trap instructions for the second microcontroller directing the second microcontroller to reset;
when the first logon state is indicative of that a logon to the host computer has not yet occurred:
in response to detecting an instruction for the second microcontroller directing the second microcontroller to reset, operating the first microcontroller to request the second logon state from the second microcontroller;
operating the first microcontroller to compare the first and second logon states and in response to detecting a change in the second logon state, replacing the first logon state with the second logon state;
when the first logon state is indicative of that a logon to the host computer has already occurred:
in response to detecting an instruction for the second microcontroller directing the second microcontroller to reset, operating the first microcontroller to direct the second microcontroller to set the second logon state to indicate that a logon has occurred.

2. The method of claim 1 wherein the first and second logon states are maintained as counters.

3. The method of claim 2 wherein detecting a change in the second logon state comprises comparing the values of the counters corresponding to the first and second logon state and deducing that a logon has occurred when the first logon state counter is less than the second logon state counter.

4. A device connected to a host computer and operable to preserve knowledge of logon authentication status to the host computer involving the device, comprising:
a first microcontroller;
a memory module connected to the first microcontroller;
a second microcontroller connected to the first microcontroller;
wherein the second microcontroller is controlled by a firmware including instructions to:
upon initialization of the device, to perform a pattern matching operation of an instruction sequence received by the second microcontroller;
in response to the sequence of operations matching a prestored sequence indicative of performance of a logon process on the host computer involving cooperation of the device, track a second logon state by the second microcontroller;
wherein the first microcontroller is controlled by a firmware including instructions to:
to receive instructions from the host computer and intended for the second microcontroller;
to maintain a first logon state indicative of the logon state of the device;
to trap instructions for the second microcontroller directing the second microcontroller to reset;
when the first logon state is indicative of that a logon to the host computer has not yet occurred to request the second logon state from the second microcontroller and to compare the first and second logon states and in response to detecting a change in the second logon state, replacing the first logon state with the second logon state;
when the first logon state is indicative of that a logon to the host computer has already occurred:
in response to detecting an instruction for the second microcontroller directing the second microcontroller to reset, direct the second microcontroller to set the second logon state to indicate that a logon has occurred.

5. A dependent claim according to claim 1 or 4 wherein the second microcontroller is a smart card.

6. A dependent claim according to claim 1 or 4 wherein the device comprises a flash memory, a USB communications interface, and wherein the first microcontroller is a flash memory microcontroller.
